(19) United States
(12) Patent Application Publication
(10) Pub. No.: US 2020/0030880 A1
(43) Pub. Date: Jan. 30, 2020

(54) ADDITIVE MANUFACTURING, LEARNING MODEL GENERATION APPARATUS, MANUFACTURING CONDITION DETERMINATION APPARATUS FOR SHAPED ARTICLE TO BE PRODUCED BY ADDITIVE MANUFACTURING AND STATUS ESTIMATION APPARATUS FOR SHAPED ARTICLE TO BE PRODUCED BY ADDITIVE MANUFACTURING

(71) Applicant: JTEKT Corporation, Osaka-shi (JP)

(72) Inventors: Takaya NAGAHAMA, Obu-shi (JP); Makoto Tano, Obu-shi (JP)

(73) Assignee: JTEKT Corporation, Osaka-shi (JP)

(21) Appl. No.: 16/517,931

(22) Filed: Jul. 22, 2019

(30) Foreign Application Priority Data
Jul. 25, 2018 (JP) 2018-139214

(51) Int. Cl. B22F 3/105; G06N 3/08; G06N 20/00

(52) U.S. Cl. CPC B22F 3/1055; G06N 3/08; B33Y 10/00; B22F 2003/1057; G06N 20/00

(57) ABSTRACT

An additive manufacturing learning model generation apparatus is applied to a method for manufacturing a shaped article by radiating a light beam onto layered metal powder and heating the metal powder. The additive manufacturing learning model generation apparatus generates a learning model for determining a manufacturing condition or for estimating a shaped article status through machine learning that uses the manufacturing condition and the shaped article status as learning data. The shaped article status is related to the shaped article when the light beam is radiated or after the light beam is radiated.

### INCORPORATION BY REFERENCE

The disclosure of Japanese Patent Application No. 2018-139214 filed on Jul. 25, 2018 including the specification, drawings and abstract, is incorporated herein by reference in its entirety.

### BACKGROUND OF THE INVENTION

### 1. Field of the Invention

The present invention relates to an additive manufacturing learning model generation apparatus, a manufacturing condition determination apparatus for a shaped article to be produced by additive manufacturing, and a status estimation apparatus for a shaped article to be produced by additive manufacturing.

### 2. Description of the Related Art

It is known that examples of metal additive manufacturing include powder bed fusion and directed energy deposition. The powder bed fusion is additive manufacturing that involves radiating a light beam (such as a laser beam or an electron beam) onto a flat bed of powder. Examples of the powder bed fusion include selective laser melting (SLM) and electron beam melting (EBM). The directed energy deposition is additive manufacturing that involves controlling the position of a head configured to radiate a light beam and feed a powder material. Examples of the directed energy deposition include laser metal deposition (LMD) and direct metal deposition (DMP).

Japanese Patent Application Publication No. 2008-255488 (JP 2008-255488 A) describes the powder bed fusion. JP 2008-255488 A describes that a shaped article is produced by additive manufacturing that involves repeatedly radiating a high-energy light beam (such as a laser beam or an electron beam) onto layered metal powder. In recent years, artificial intelligence has been developed rapidly along with improvement in processing speeds of computers. For example, Japanese Patent Application Publication No. 2017-164801 (JP 2017-164801 A) describes that laser machining condition data is generated by machine learning.

In the additive manufacturing for shaped articles, a variety of elements are present as elements of manufacturing conditions. Therefore, it is not easy to determine the manufacturing conditions. For example, a new material cannot be determined as the manufacturing condition in order to satisfy required quality of shaped articles. Further, it is not easy to carry out 100% inspection of the quality of shaped articles. There is a demand to estimate the quality of shaped articles based on the manufacturing conditions. It is particularly desirable that the possibility of failure can be grasped as early as possible because a considerable time is required to manufacture shaped articles.

### SUMMARY OF THE INVENTION

It is one object of the present invention to provide, in manufacture of a shaped article to be produced by additive manufacturing, an additive manufacturing learning model generation apparatus, a manufacturing condition determination apparatus for the shaped article to be produced by additive manufacturing, and a status estimation apparatus for the shaped article to be produced by additive manufacturing.

An additive manufacturing learning model generation apparatus according to one aspect of the present invention is applied to a method for manufacturing a shaped article by radiating a light beam onto layered metal powder and heating the metal powder. The additive manufacturing learning model generation apparatus is configured to generate a learning model for determining a manufacturing condition or for estimating a shaped article status through machine learning that uses the manufacturing condition and the shaped article status as learning data. The shaped article status is related to the shaped article when the light beam is radiated or after the light beam is radiated.

The learning model is generated through the machine learning that uses the manufacturing condition and the shaped article status as the learning data. That is, the learning model defines at least a relationship between the manufacturing condition of the shaped article and the shaped article status related to the shaped article. The learning model may be used as a model for determining the manufacturing condition of the shaped article, or as a model for estimating the shaped article status related to the shaped article. By using the machine learning, the relationship between the manufacturing condition and the shaped article status can be defined easily. Thus, according to the present invention, the manufacturing condition of the shaped article can be determined easily, or the shaped article status can be estimated easily.

A manufacturing condition determination apparatus for a shaped article to be produced by additive manufacturing according to another aspect of the present invention includes a condition determination unit configured to determine, by using the learning model of the additive manufacturing learning model generation apparatus described above, the manufacturing condition while the shaped article status is set as the input data. Thus, the manufacturing condition of the shaped article can be determined easily.

A status estimation apparatus for a shaped article to be produced by additive manufacturing according to still another aspect of the present invention includes an estimation unit configured to estimate, by using the learning model of the additive manufacturing learning model generation apparatus described above, the shaped article status while the manufacturing condition is set as the input data. Thus, the shaped article status related to the shaped article can be estimated easily.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a diagram illustrating an additive manufacturing apparatus;

FIG. 2 is a block diagram illustrating a manufacturing system;

FIG. 3 is a diagram illustrating information stored in a manufacturing condition database;

FIG. 4 is a diagram illustrating information stored in a shaped article status database;

FIG. 5 is a diagram illustrating information stored in a target shaped article status database;

FIG. 6 is a diagram illustrating relationships between input data and output data in a first learning model to a fifth learning model of a machine learning apparatus;

FIG. 7 is a diagram illustrating relationships between input data and output data in a sixth learning model and a seventh learning model of the machine learning apparatus; and

FIG. 8 is a diagram illustrating relationships between input data and output data in an eighth learning model to a tenth learning model of the machine learning apparatus.

### DETAILED DESCRIPTION OF EMBODIMENTS

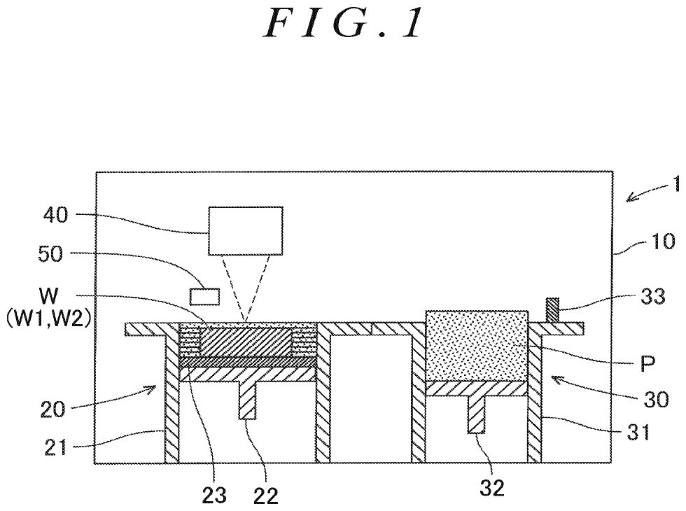

An additive manufacturing apparatus 1 that is a principal element of manufacture of a shaped article W is described with reference to FIG. 1. Powder bed fusion, directed energy deposition, or the like may be applied to the additive manufacturing apparatus 1. This embodiment is described taking an exemplary case where the powder bed fusion is applied to the additive manufacturing apparatus 1. That is, the additive manufacturing apparatus 1 manufactures the shaped article W (first-stage shaped article) by repeatedly radiating a light beam onto layered metal powder P.

Examples of the light beam include a laser beam, an electron beam, and various other beams with which the metal powder P can be melted. Further, a laser having a near-infrared wavelength, a laser having a far-infrared wavelength (CO₂ laser), a semiconductor laser, or various other lasers may be applied to the laser beam. The beam is determined as appropriate depending on the target metal powder P. Further, aluminum, copper, steels such as maraging steel and Inconel, stainless steel, or various other metal materials may be applied to the metal powder P.

As illustrated in FIG. 1, the additive manufacturing apparatus 1 includes a chamber 10, a shaped article support device 20, a powder feed device 30, a light beam radiation device 40, and a detection device 50. The chamber 10 is configured such that internal air can be substituted by inert gas such as helium, nitrogen, or argon. The chamber 10 may be configured such that the internal pressure can be reduced instead of substituting the internal air by inert gas.

The shaped article support device 20 is provided inside the chamber 10. The shaped article support device 20 is a portion for forming the shaped article W. The shaped article support device 20 includes a shaping container 21, an elevational table 22, and a base 23. The shaping container 21 has an opening at the top, and also has inner walls parallel to a vertical axis. The elevational table 22 is provided inside the shaping container 21 so as to be movable in the vertical direction along the inner walls. The base 23 is removably attached to the upper face of the elevational table 22. The upper face of the base 23 is a portion for manufacturing the shaped article W. That is, the base 23 is a member configured such that the metal powder P is layered on the upper face and the shaped article W is supported during the manufacture. By changing the positioning height of the elevational table 22, the layer thickness of the metal powder P can be changed.

The powder feed device 30 is provided inside the chamber 10 so as to adjoin the shaped article support device 20. The powder feed device 30 includes a powder container 31, a feed table 32, and a recoater 33. The powder container 31 has an opening at the top. The height of the opening of the powder container 31 is equal to the height of the opening of the shaping container 21. The powder container 31 has inner walls parallel to a vertical axis. The feed table 32 is provided inside the powder container 31 so as to be movable in the vertical direction along the inner walls. The powder container 31 contains the metal powder P in a region above the feed table 32.

The recoater 33 is provided so as to be reciprocable along a plane including the opening of the shaping container 21 and the opening of the powder container 31 over the entire regions of both the openings. When the recoater 33 moves from right to left in FIG. 1, the recoater 33 carries the metal powder P projecting from the opening of the powder container 31 toward the shaping container 21. The recoater 33 deposits the carried metal powder P into a layer on the upper face of the base 23.

In addition to the structure described above, a mover configured to move the recoater 33 may have a function of feeding the metal powder P. In this case, the metal powder P is flattened by the recoater 33 while being fed onto the base 23.

The light beam radiation device 40 radiates a light beam onto the surface of the metal powder P layered on the upper face of the base 23. As described above, the light beam is a laser beam, an electron beam, or the like. By radiating the light beam onto the layered metal powder P, the light beam radiation device 40 heats the metal powder P to a temperature equal to or higher than the melting point of the metal powder P. The metal powder P is then melted and solidified, thereby manufacturing a fused layer of the shaped article. That is, adjacent grains of the metal powder P are fused together by melt bonding.

The light beam radiation device 40 changes a radiation position, laser power, a scanning speed, a scanning pitch, a radiation spot diameter, and the like based on a program set in advance. By changing the radiation position, a desired layer of the shaped article can be manufactured. By changing the laser power, the amount of heat applied to an irradiated position of the metal powder P is changed. Thus, the bonding strength of grains of the metal powder P can be changed.

For example, the detection device 50 is (a) a temperature detection device configured to measure an irradiated point temperature of the shaped article W when the light beam is radiated, (b) an imaging device configured to measure a light emission amount when the light beam is radiated to acquire a sputter amount generated through the radiation of the light beam, (c) an imaging device configured to acquire a shaped surface image of the shaped article W after the light beam is radiated, or (d) an imaging device configured to acquire a weld pool size when the light beam is radiated. In this embodiment, the detection device 50 has all the functions (a) to (d). However, the detection device 50 may have some of the functions.

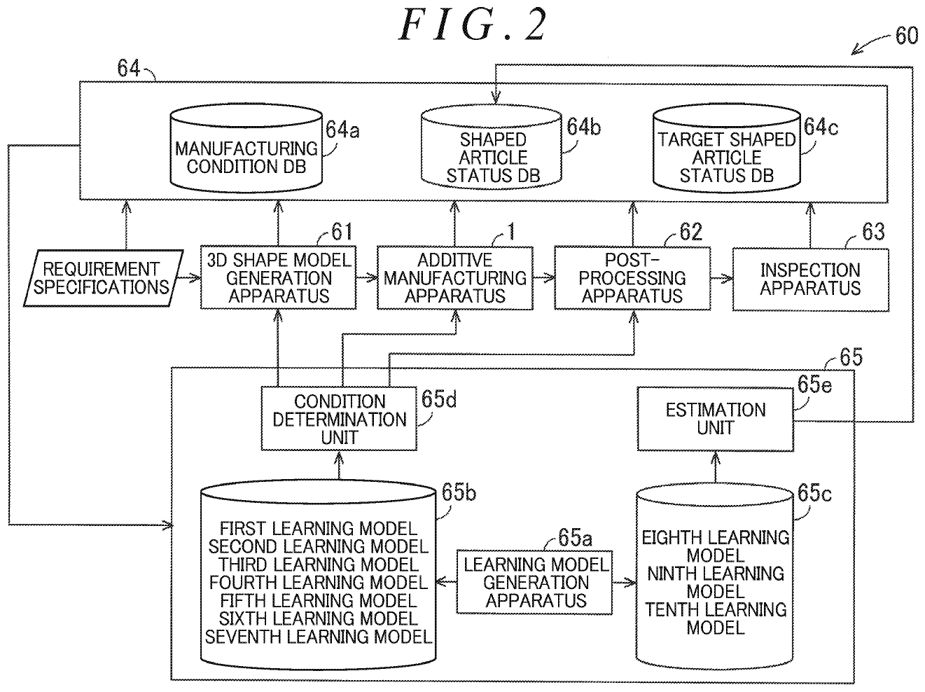

Next, a manufacturing system 60 for the shaped article W, which includes the additive manufacturing apparatus 1 as a principal element, is described with reference to FIG. 2. As illustrated in FIG. 2, the manufacturing system 60 includes a three-dimensional (3D) shape model generation apparatus 61, the additive manufacturing apparatus 1 (illustrated in FIG. 1), a post-processing apparatus 62, and an inspection apparatus 63 as a manufacturing line.

The 3D shape model generation apparatus 61 generates a 3D shape model based on requirement specifications so that the additive manufacturing apparatus 1 can manufacture the shaped article W (first-stage shaped article W1). Examples of the requirement specifications include a product shape, product quality, a product function, product properties such as a main component of a material of the metal powder P, a condition of attachment to a mating member, and a space from the mating member. Examples of the product quality include accuracy of the product shape, product strength, and product durability.

For example, the 3D shape model generation apparatus 61 generates an optimum 3D shape model by applying computer-aided engineering (CAE). For example, the 3D shape model contains pieces of information on a 3D design shape, a shaping posture of the 3D design shape, components and physical properties of the material of the metal powder P, and a mean particle diameter of the metal powder P. Those pieces of information constitute a part of first-stage manufacturing conditions.

The additive manufacturing apparatus 1 acquires the 3D shape model generated by the 3D shape model generation apparatus 61, and manufactures the first-stage shaped article W1 based on the 3D shape model. In the additive manufacturing apparatus 1, shaping conditions such as the laser power, the scanning speed, the scanning pitch, the radiation spot diameter, and the layer thickness are set as other elements of the first-stage manufacturing conditions. The shaping conditions such as the laser power, the scanning speed, the scanning pitch, the radiation spot diameter, and the layer thickness are set so as to satisfy the product quality and the product function that are the requirement specifications.

The additive manufacturing apparatus 1 manufactures the first-stage shaped article W1 based on the shaping conditions that are other elements of the first-stage manufacturing conditions. When the first-stage shaped article W1 is manufactured, the detection device 50 of the additive manufacturing apparatus 1 acquires various types of information. That is, the detection device 50 acquires, for example, the irradiated point temperature of the shaped article W when the light beam is radiated, the sputter amount generated through the radiation of the light beam, the shaped surface image of the shaped article W after the light beam is radiated, and the weld pool size when the light beam is radiated.

The post-processing apparatus 62 performs post-processing for the first-stage shaped article W1. For example, the post-processing apparatus 62 performs heat treatment or additional processing to manufacture a second-stage shaped article W2. The post-processing apparatus 62 performs the heat treatment for the first-stage shaped article W1 based on set heat treatment conditions serving as second-stage manufacturing conditions. Examples of the additional processing include cutting and grinding, as typified by surface finishing, drilling, and tapping. The post-processing apparatus 62 performs the additional processing for the first-stage shaped article W1 based on set machining conditions serving as the second-stage manufacturing conditions.

The inspection apparatus 63 evaluates the quality of the second-stage shaped article W2. The inspection apparatus 63 inspects whether the second-stage shaped article W2 satisfies the product quality that is the requirement specification. For example, the inspection apparatus 63 inspects the accuracy of the product shape, the product strength, and the product durability. For example, if the additive manufacturing fails, the second-stage shaped article W2 has a defect in shape accuracy, has a void inside, or lacks the product strength. The second-stage shaped article W2 lacks the product strength due to a failure in heat treatment as well. That is, the inspection apparatus 63 can inspect those failures.

The inspection apparatus 63 may evaluate the quality of the first-stage shaped article W1. In this case, the inspection apparatus 63 inspects various statuses of the first-stage shaped article W1 before the post-processing apparatus 62 performs the post-processing. If the manufacturing line does not have the post-processing apparatus 62, the inspection apparatus 63 evaluates the quality of the first-stage shaped article W1 as a matter of course.

As illustrated in FIG. 2, the manufacturing system 60 includes a database 64 and a machine learning apparatus 65 in addition to the components 61, 1, 62, and 63 in the manufacturing line. The database 64 stores various types of data. The machine learning apparatus 65 is applied to methods for manufacturing the shaped articles W, W1, and W2.

The database 64 is communicably connected to the components 61, 1, 62, and 63 in the manufacturing line. For example, the database 64 stores data related to the input requirement specifications, data related to the 3D shape model generated by the 3D shape model generation apparatus 61, shaping condition data of the additive manufacturing apparatus 1, data acquired by the detection device 50, condition data of the post-processing apparatus 62, and data acquired by the inspection apparatus 63. The database 64 accumulates data related to a plurality of the shaped articles W. When a new shaped article W is manufactured, data related to the shaped article W is additionally stored in the database 64.

The database 64 includes a manufacturing condition database (DB) 64a, a shaped article status database (DB) 64b, and a target shaped article status database (DB) 64c. The manufacturing condition database 64a and the shaped article status database 64b are stored in association with each other for each target shaped article W.

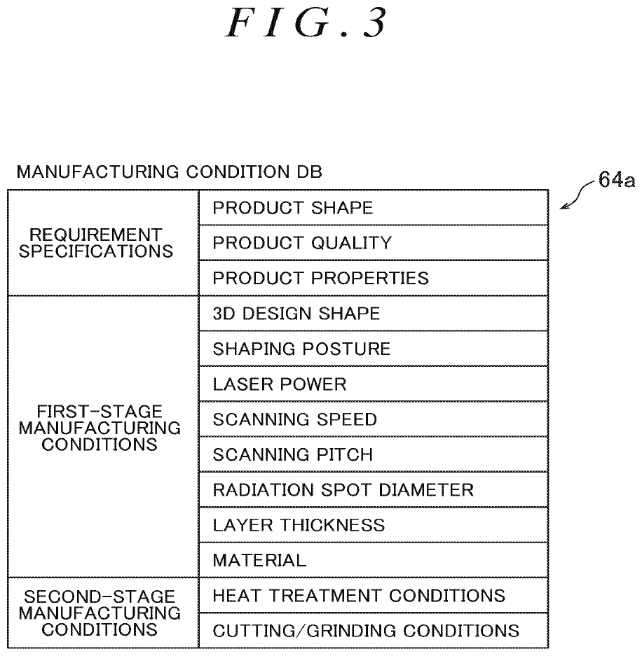

As illustrated in FIG. 3, the manufacturing condition database 64a stores manufacturing condition data. The manufacturing condition data includes data related to the requirement specifications, data related to the first-stage manufacturing conditions, and data related to the second-stage manufacturing conditions. Examples of the data related to the requirement specifications stored in the manufacturing condition database 64a include the product shape, the product quality, and the product properties. Examples of the data related to the first-stage manufacturing conditions stored in the manufacturing condition database 64a include pieces of data related to the 3D design shape, the shaping posture of the 3D design shape, the laser power, the scanning speed, the scanning pitch, the radiation spot diameter, the layer thickness, and the material of the metal powder P. Examples of the data related to the material of the metal powder P include information on the components and physical properties of the material of the metal powder P and the mean particle diameter of the metal powder P. Examples of the data related to the second-stage manufacturing conditions stored in the manufacturing condition database 64a include the heat treatment conditions and cutting/grinding conditions.

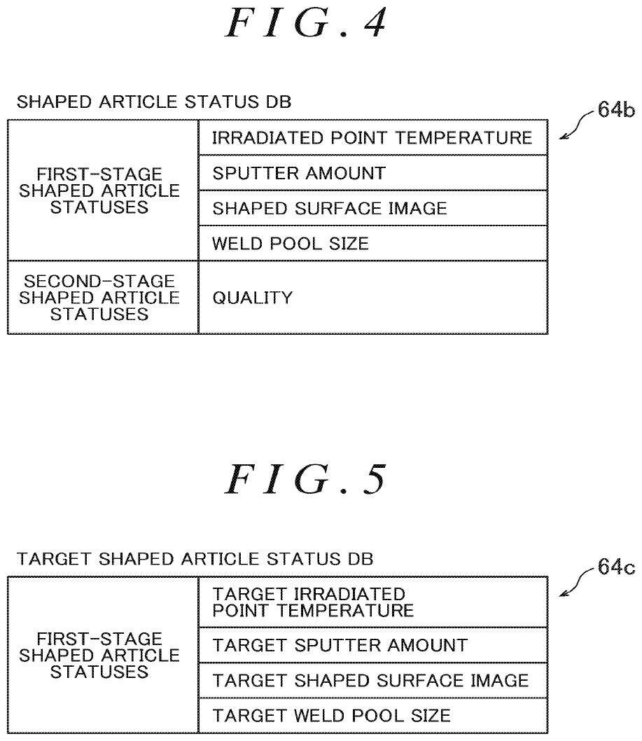

As illustrated in FIG. 4, the shaped article status database 64b stores shaped article status data. The shaped article status data includes data related to first-stage shaped article statuses acquired by the detection device 50 of the additive manufacturing apparatus 1, and data related to second-stage shaped article statuses acquired by the inspection apparatus 63. Examples of the data related to the first-stage shaped article statuses include the irradiated point temperature, the sputter amount, the shaped surface image, and the weld pool size. The data related to the second-stage shaped article statuses is data related to the quality acquired by the inspection apparatus 63.

As illustrated in FIG. 5, the target shaped article status database 64c stores target shaped article status data. Examples of the target shaped article status data include a target irradiated point temperature, a target sputter amount, a target shaped surface image, and a target weld pool size. For example, the target irradiated point temperature is set to a temperature obtained theoretically based on the material of the metal powder P. For example, the target sputter amount, the target shaped surface image, and the target weld pool size are set based on the product quality.

The machine learning apparatus 65 (a) generates a first learning model to a seventh learning model for determining the manufacturing conditions, (b) generates an eighth learning model to a tenth learning model for estimating the shaped article statuses, (c) determines the manufacturing conditions by using the first learning model to the seventh learning model, and (d) estimates the statuses of the shaped article W by using the eighth learning model to the tenth learning model. The machine learning apparatus 65 corresponds to a manufacturing condition determination apparatus for a shaped article to be produced by additive manufacturing according to the present invention, and a status estimation apparatus for a shaped article to be produced by additive manufacturing according to the present invention.

That is, the machine learning apparatus 65 includes a unit that functions in a leaning phase corresponding to the operations (a) and (c), and a unit that functions in an inference phase corresponding to the operations (b) and (d). The machine learning apparatus 65 is communicably connected to the database 64 and to the components 61, 1, 62, and 63 in the manufacturing line. The machine learning apparatus 65 includes an additive manufacturing learning model generation apparatus 65a (hereinafter referred to as a learning model generation apparatus), a first-group learning model storage unit 65b, a second-group learning model storage unit 65c, a condition determination unit 65d, and an estimation unit 65e.

The learning model generation apparatus 65a acquires the manufacturing condition data stored in the manufacturing condition database 64a and the shaped article status data stored in the shaped article status database 64b, and performs machine learning that uses the manufacturing condition data and the shaped article status data as learning data. The learning model generation apparatus 65a generates the first learning model to the seventh learning model, and stores the generated first learning model to the generated seventh learning model in the first-group learning model storage unit 65b. The learning model generation apparatus 65a generates the eighth learning model to the tenth learning model, and stores the generated eighth learning model to the generated tenth learning model in the second-group learning model storage unit 65c.

For example, the learning model generation apparatus 65a generates a learning model based on a supervised learning algorithm by using the manufacturing condition data and the shaped article status data as the learning data. The learning model generation apparatus 65a may generate the learning model by applying a machine learning algorithm other than the supervised learning algorithm. The same applies to generation of various learning models described below.

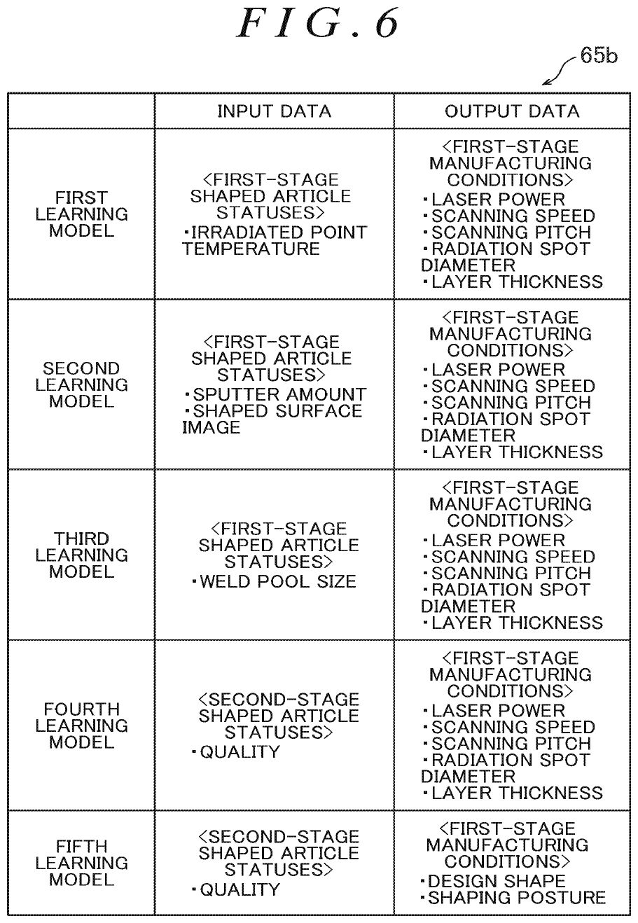

As illustrated in FIG. 6, the first learning model is obtained through machine learning that uses, as the learning data, at least the irradiated point temperature serving as the first-stage shaped article status and the laser power, the scanning speed, the scanning pitch, the radiation spot diameter, and the layer thickness serving as the first-stage manufacturing conditions. The first learning model is configured such that, when the irradiated point temperature is set as input data, the laser power, the scanning speed, the scanning pitch, the radiation spot diameter, and the layer thickness can be set as output data. That is, the first learning model is configured to determine the laser power, the scanning speed, the scanning pitch, the radiation spot diameter, and the layer thickness that are the shaping conditions when the irradiated point temperature is set as input data.

The first learning model may be configured to determine all the shaping conditions, or determine one or a plurality of the shaping conditions. The input data of the first learning model may include information other than the irradiated point temperature.

As illustrated in FIG. 6, the second learning model is obtained through machine learning that uses, as the learning data, at least the sputter amount and the shaped surface image serving as the first-stage shaped article statuses and the laser power, the scanning speed, the scanning pitch, the radiation spot diameter, and the layer thickness serving as the first-stage manufacturing conditions. The second learning model is configured such that, when the sputter amount and the shaped surface image are set as input data, the laser power, the scanning speed, the scanning pitch, the radiation spot diameter, and the layer thickness can be set as output data. That is, the second learning model is configured to determine the laser power, the scanning speed, the scanning pitch, the radiation spot diameter, and the layer thickness that are the shaping conditions when the sputter amount and the shaped surface image are set as input data.

The input data of the second learning model may be the sputter amount or the shaped surface image. The second learning model may be configured to determine all the shaping conditions, or determine one or a plurality of the shaping conditions. The input data of the second learning model may include information other than the sputter amount and the shaped surface image.

As illustrated in FIG. 6, the third learning model is obtained through machine learning that uses, as the learning data, at least the weld pool size serving as the first-stage shaped article status and the laser power, the scanning speed, the scanning pitch, the radiation spot diameter, and the layer thickness serving as the first-stage manufacturing conditions. The third learning model is configured such that, when the weld pool size is set as input data, the laser power, the scanning speed, the scanning pitch, the radiation spot diameter, and the layer thickness can be set as output data. That is, the third learning model is configured to determine the laser power, the scanning speed, the scanning pitch, the radiation spot diameter, and the layer thickness that are the shaping conditions when the weld pool size is set as input data.

The third learning model may be configured to determine all the shaping conditions, or determine one or a plurality of the shaping conditions. The input data of the third learning model may include information other than the weld pool size.

As illustrated in FIG. 6, the fourth learning model is obtained through machine learning that uses, as the learning data, at least the quality serving as the second-stage shaped article status and the laser power, the scanning speed, the scanning pitch, the radiation spot diameter, and the layer thickness serving as the first-stage manufacturing conditions. The fourth learning model is configured such that, when the quality is set as input data, the laser power, the scanning speed, the scanning pitch, the radiation spot diameter, and the layer thickness can be set as output data. That is, the fourth learning model is configured to determine the laser power, the scanning speed, the scanning pitch, the radiation spot diameter, and the layer thickness that are the shaping conditions when the quality is set as input data.

The fourth learning model may be configured to determine all the shaping conditions, or determine one or a plurality of the shaping conditions. The input data of the fourth learning model may include information other than the quality. The input data of the fourth learning model is the quality of the second-stage shaped article W2 serving as the second-stage shaped article status. However, the input data of the fourth learning model is the quality of the first-stage shaped article W1 when the inspection apparatus 63 acquires the quality of the first-stage shaped article W1.

As illustrated in FIG. 6, the fifth learning model is obtained through machine learning that uses, as the learning data, at least the quality serving as the second-stage shaped article status and the 3D design shape and the shaping posture serving as the first-stage manufacturing conditions. The fifth learning model is configured such that, when the quality is set as input data, the 3D design shape and the shaping posture can be set as output data. That is, the fifth learning model is configured to determine the 3D design shape and the shaping posture when the quality is set as input data.

The fifth learning model may be configured to determine both the 3D design shape and the shaping posture, or determine the 3D design shape or the shaping posture. The input data of the fifth learning model may include information other than the quality. The input data of the fifth learning model is the quality of the second-stage shaped article W2 serving as the second-stage shaped article status. However, the input data of the fifth learning model is the quality of the first-stage shaped article W1 when the inspection apparatus 63 acquires the quality of the first-stage shaped article W1.

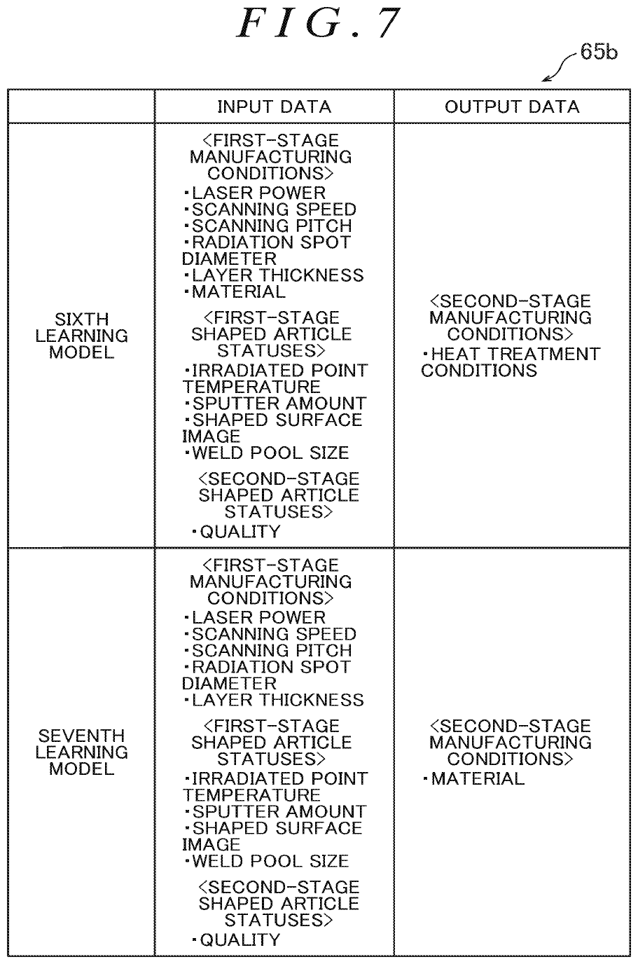

As illustrated in FIG. 7, the sixth learning model is obtained through machine learning that uses, as the learning data, the laser power, the scanning speed, the scanning pitch, the radiation spot diameter, the layer thickness, and the material of the metal powder P serving as the first-stage manufacturing conditions, the irradiated point temperature, the sputter amount, the shaped surface image, and the weld pool size serving as the first-stage shaped article statuses, the quality serving as the second-stage shaped article status, and the heat treatment conditions serving as the second-stage manufacturing conditions. The sixth learning model is configured such that, when the first-stage manufacturing conditions, the first-stage shaped article statuses, and the second-stage shaped article status described above are set as input data, the heat treatment conditions can be set as output data. That is, the sixth learning model is configured to determine the heat treatment conditions when the first-stage manufacturing conditions, the first-stage shaped article statuses, and the second-stage shaped article status described above are set as input data.

The input data of the sixth learning model may be only a part of the information described above. The input data of the sixth learning model is the quality of the second-stage shaped article W2 serving as the second-stage shaped article status. However, the input data of the sixth learning model is the quality of the first-stage shaped article W1 when the inspection apparatus 63 acquires the quality of the first-stage shaped article W1.

As illustrated in FIG. 7, the seventh learning model is obtained through machine learning that uses, as the learning data, the laser power, the scanning speed, the scanning pitch, the radiation spot diameter, and the layer thickness serving as the first-stage manufacturing conditions, the irradiated point temperature, the sputter amount, the shaped surface image, and the weld pool size serving as the first-stage shaped article statuses, the quality serving as the second-stage shaped article status, and the material of the metal powder P serving as the first-stage manufacturing condition. The seventh learning model is configured such that, when the first-stage manufacturing conditions, the first-stage shaped article statuses, and the second-stage shaped article status described above are set as input data, the material of the metal powder P can be set as output data. That is, the seventh learning model is configured to determine the material of the metal powder P when the first-stage manufacturing conditions, the first-stage shaped article statuses, and the second-stage shaped article status described above are set as input data. Specifically, the seventh learning model is configured to determine the components of the material of the metal powder P and component ratios of the material. The component ratio may have a numerical range, or may be a specific value. The seventh learning model may be limited so as to exclusively output existing components of the material of the metal powder P and the ratios of the existing components, or may output non-existing components and the ratios of the non-existing components.

The input data of the seventh learning model may be only a part of the information described above. The input data of the seventh learning model is the quality of the second-stage shaped article W2 serving as the second-stage shaped article status. However, the input data of the seventh learning model is the quality of the first-stage shaped article W1 when the inspection apparatus 63 acquires the quality of the first-stage shaped article W1.

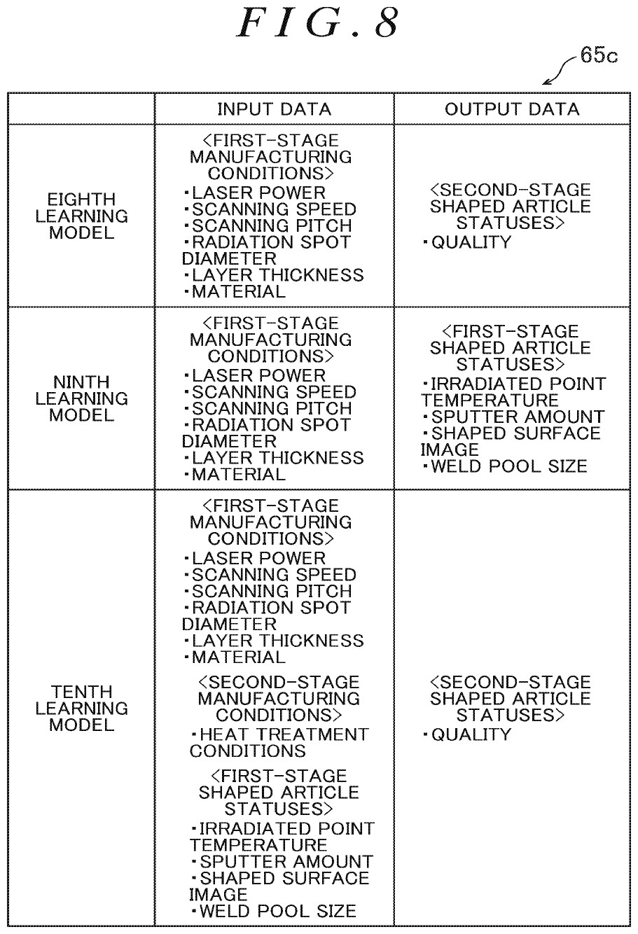

As illustrated in FIG. 8, the eighth learning model is obtained through machine learning that uses, as the learning data, the laser power, the scanning speed, the scanning pitch, the radiation spot diameter, the layer thickness, and the material of the metal powder P serving as the first-stage manufacturing conditions and the quality serving as the second-stage shaped article status. The eighth learning model is configured such that, when the first-stage manufacturing conditions described above are set as input data, the quality of the second-stage shaped article W2 can be set as output data. That is, the eighth learning model is configured to estimate the quality of the second-stage shaped article W2 when the first-stage manufacturing conditions described above are set as input data.

The input data of the eighth learning model may be only a part of the information related to the first-stage manufacturing conditions described above. The eighth learning model performs the machine learning that uses, as the learning data, the quality of the second-stage shaped article W2 serving as the second-stage shaped article status. However, the eighth learning model performs machine learning that uses the quality of the first-stage shaped article W1 as the learning data when the inspection apparatus 63 acquires the quality of the first-stage shaped article W1. In this case, the output data to be estimated is the quality of the first-stage shaped article W1.

As illustrated in FIG. 8, the ninth learning model is obtained through machine learning that uses, as the learning data, the laser power, the scanning speed, the scanning pitch, the radiation spot diameter, the layer thickness, and the material of the metal powder P serving as the first-stage manufacturing conditions and the irradiated point temperature, the sputter amount, the shaped surface image, and the weld pool size serving as the first-stage shaped article statuses. The ninth learning model is configured such that, when the first-stage manufacturing conditions described above are set as input data, various statuses of the first-stage shaped article W1 can be set as output data. That is, the ninth learning model is configured to estimate various statuses of the first-stage shaped article W1 when the first-stage manufacturing conditions described above are set as input data. The input data of the ninth learning model may be only a part of the information related to the first-stage manufacturing conditions described above. The output data of the ninth learning model may be only a part of the information related to the first-stage shaped article statuses described above.

As illustrated in FIG. 8, the tenth learning model is obtained through machine learning that uses, as the learning data, the laser power, the scanning speed, the scanning pitch, the radiation spot diameter, the layer thickness, and the material of the metal powder P serving as the first-stage manufacturing conditions, the heat treatment conditions serving as the second-stage manufacturing conditions, the irradiated point temperature, the sputter amount, the shaped surface image, and the weld pool size serving as the first-stage shaped article statuses, and the quality serving as the second-stage shaped article status. The tenth learning model is configured such that, when the first-stage manufacturing conditions, the second-stage manufacturing conditions, and the first-stage shaped article statuses described above are set as input data, the quality of the second-stage shaped article W2 can be set as output data. That is, the tenth learning model is configured to estimate the quality of the second-stage shaped article W2 when the first-stage manufacturing conditions, the second-stage manufacturing conditions, and the first-stage shaped article statuses described above are set as input data. The input data of the tenth learning model may be only a part of the information related to the first-stage manufacturing conditions described above.

The condition determination unit 65d determines the manufacturing conditions by using the first learning model to the seventh learning model. The manufacturing conditions of the 3D shape model generation apparatus 61, the additive manufacturing apparatus 1, and the post-processing apparatus 62 in the manufacturing line are changed based on the manufacturing conditions determined by the condition determination unit 65d.

When the first learning model is used, the condition determination unit 65d determines the laser power, the scanning speed, the scanning pitch, the radiation spot diameter, and the layer thickness that are the shaping conditions by setting, as the input data, the target irradiated point temperature stored in the target shaped article status database 64c. When the first learning model is used, the condition determination unit 65d may determine the shaping conditions in consideration of a difference between the target irradiated point temperature and an actual irradiated point temperature.

When the second learning model is used, the condition determination unit 65d determines the laser power, the scanning speed, the scanning pitch, the radiation spot diameter, and the layer thickness that are the shaping conditions by setting, as the input data, the target sputter amount and the target shaped surface image stored in the target shaped article status database 64c. When the second learning model is used, the condition determination unit 65d may determine the shaping conditions in consideration of a difference between the target sputter amount and an actual sputter amount and a difference between the target shaped surface image and an actual shaped surface image.

When the third learning model is used, the condition determination unit 65d determines the laser power, the scanning speed, the scanning pitch, the radiation spot diameter, and the layer thickness that are the shaping conditions by setting, as the input data, the target weld pool size stored in the target shaped article status database 64c. When the third learning model is used, the condition determination unit 65d may determine the shaping conditions in consideration of a difference between the target weld pool size and an actual weld pool size.

When the fourth learning model is used, the condition determination unit 65d determines the laser power, the scanning speed, the scanning pitch, the radiation spot diameter, and the layer thickness that are the shaping conditions by setting, as the input data, the product quality that is the requirement specification stored in the manufacturing condition database 64a. When the fourth learning model is used, the condition determination unit 65d may determine the shaping conditions in consideration of a difference between the product quality that is the requirement specification and actual quality.

When the fifth learning model is used, the condition determination unit 65d determines the 3D design shape and the shaping posture by setting, as the input data, the product quality that is the requirement specification stored in the manufacturing condition database 64a. When the fifth learning model is used, the condition determination unit 65d may determine the 3D design shape and the shaping posture in consideration of the difference between the product quality that is the requirement specification and the actual quality.

When the sixth learning model is used, the condition determination unit 65d determines the heat treatment conditions by setting, as the input data, the laser power, the scanning speed, the scanning pitch, the radiation spot diameter, the layer thickness, and the material of the metal powder P serving as the first-stage manufacturing conditions stored in the manufacturing condition database 64a, the irradiated point temperature, the sputter amount, the shaped surface image, and the weld pool size serving as the first-stage shaped article statuses stored in the shaped article status database 64b, and the product quality that is the requirement specification stored in the manufacturing condition database 64a. When the sixth learning model is used, the condition determination unit 65d may determine the heat treatment conditions in consideration of the difference between the product quality that is the requirement specification and the actual quality.

When the seventh learning model is used, the condition determination unit 65d determines the material of the metal powder P by setting, as the input data, the laser power, the scanning speed, the scanning pitch, the radiation spot diameter, and the layer thickness serving as the first-stage manufacturing conditions stored in the manufacturing condition database 64a, the irradiated point temperature, the sputter amount, the shaped surface image, and the weld pool size serving as the first-stage shaped article statuses stored in the shaped article status database 64b, and the product quality that is the requirement specification stored in the manufacturing condition database 64a. When the seventh learning model is used, the condition determination unit 65d may determine the material of the metal powder P in consideration of the difference between the product quality that is the requirement specification and the actual quality.

Specifically, the condition determination unit 65d can determine the components of the material of the metal powder P and the component ratios of the material by using the seventh learning model. The component ratio may have a numerical range, or may be a specific value. The condition determination unit 65d may be limited so as to exclusively output existing components and the ratios of the existing components as the components of the material of the metal powder P and the component ratios of the material to be determined by using the seventh learning model, or may output non-existing components and the ratios of the non-existing components.

The estimation unit 65e estimates the statuses of the shaped articles (first-stage shaped article W1 and second-stage shaped article W2) by using the eighth learning model to the tenth learning model. The estimation unit 65e stores the estimated statuses of the shaped articles in the shaped article status database 64b.

When the eighth learning model is used, the estimation unit 65e estimates the quality of the second-stage shaped article W2 by setting, as the input data, the laser power, the scanning speed, the scanning pitch, the radiation spot diameter, the layer thickness, and the material of the metal powder P serving as the first-stage manufacturing conditions stored in the manufacturing condition database 64a. The estimated quality of the second-stage shaped article W2 corresponds to quality obtained based on current manufacturing conditions. The estimation unit 65e stores the estimated quality of the second-stage shaped article W2 in the shaped article status database 64b.

When the ninth learning model is used, the estimation unit 65e estimates the irradiated point temperature, the sputter amount, the shaped surface image, and the weld pool size serving as the first-stage shaped article statuses by setting, as the input data, the laser power, the scanning speed, the scanning pitch, the radiation spot diameter, the layer thickness, and the material of the metal powder P serving as the first-stage manufacturing conditions stored in the manufacturing condition database 64a. The estimated irradiated point temperature, the estimated sputter amount, the estimated shaped surface image, and the estimated weld pool size serving as the first-stage shaped article statuses correspond to results obtained based on current manufacturing conditions. The estimation unit 65e stores the estimated irradiated point temperature, the estimated sputter amount, the estimated shaped surface image, and the estimated weld pool size serving as the first-stage shaped article statuses in the shaped article status database 64b.

When the tenth learning model is used, the estimation unit 65e estimates the quality of the second-stage shaped article W2 by setting, as the input data, the laser power, the scanning speed, the scanning pitch, the radiation spot diameter, the layer thickness, and the material of the metal powder P serving as the first-stage manufacturing conditions stored in the manufacturing condition database 64a, the heat treatment conditions serving as the second-stage manufacturing conditions, and the irradiated point temperature, the sputter amount, the shaped surface image, and the weld pool size serving as the first-stage shaped article statuses. The estimated quality of the second-stage shaped article W2 corresponds to quality obtained based on current manufacturing conditions. The estimation unit 65e stores the estimated quality of the second-stage shaped article W2 in the shaped article status database 64b.

As described above, each learning model is generated through the machine learning that uses the manufacturing conditions and the shaped article statuses as the learning data. That is, the learning model defines a relationship between the manufacturing conditions of the shaped article W and the shaped article statuses related to the shaped article W. The learning model may be used as a model for determining the manufacturing conditions of the shaped article W, or as a model for estimating the shaped article statuses related to the shaped article W. By using the machine learning, the relationship between the manufacturing conditions and the shaped article statuses can be defined easily. Thus, the machine learning apparatus 65 can easily determine the manufacturing conditions of the shaped article W, or can easily estimate the shaped article statuses.

What is claimed is:

1. An additive manufacturing learning model generation apparatus to be applied to a method for manufacturing a shaped article by radiating a light beam onto layered metal powder and heating the metal powder,
the additive manufacturing learning model generation apparatus being configured to generate a learning model for determining a manufacturing condition or for estimating a shaped article status through machine learning that uses the manufacturing condition and the shaped article status as learning data, the shaped article status being related to the shaped article when the light beam is radiated or after the light beam is radiated.

2. The additive manufacturing learning model generation apparatus according to claim 1, wherein
the manufacturing condition is at least one of laser power, a scanning speed, a scanning pitch, a radiation spot diameter, a layer thickness, and a material of the metal powder,
the shaped article status is an irradiated point temperature of the shaped article when the light beam is radiated, and
the learning model is a model for determining, as the manufacturing condition to be estimated, the at least one of the laser power, the scanning speed, the scanning pitch, the radiation spot diameter, the layer thickness, and the material of the metal powder when the irradiated point temperature that is the shaped article status is set as input data.

3. The additive manufacturing learning model generation apparatus according to claim 1, wherein
the manufacturing condition is at least one of laser power, a scanning speed, a scanning pitch, a radiation spot diameter, a layer thickness, and a material of the metal powder,
the shaped article status is at least one of a sputter amount generated when the light beam is radiated and a shaped surface image of the shaped article after the light beam is radiated, and
the learning model is a model for determining, as the manufacturing condition to be estimated, the at least one of the laser power, the scanning speed, the scanning pitch, the radiation spot diameter, the layer thickness, and the material of the metal powder when the at least one of the sputter amount and the shaped surface image that are the shaped article status is set as input data.

4. The additive manufacturing learning model generation apparatus according to claim 1, wherein
the manufacturing condition is at least one of laser power, a scanning speed, a scanning pitch, a radiation spot diameter, a layer thickness, and a material of the metal powder,
the shaped article status is a weld pool size when the light beam is radiated, and
the learning model is a model for determining, as the manufacturing condition to be estimated, the at least one of the laser power, the scanning speed, the scanning pitch, the radiation spot diameter, the layer thickness, and the material of the metal powder when the weld pool size that is the shaped article status is set as input data.

5. The additive manufacturing learning model generation apparatus according to claim 1, wherein
the manufacturing condition is at least one of laser power, a scanning speed, a scanning pitch, a radiation spot diameter, a layer thickness, and a material of the metal powder,
the shaped article status is quality of the shaped article, and
the learning model is a model for determining, as the manufacturing condition to be estimated, the at least one of the laser power, the scanning speed, the scanning pitch, the radiation spot diameter, the layer thickness, and the material of the metal powder when the quality that is the shaped article status is set as input data.

6. The additive manufacturing learning model generation apparatus according to claim 1, wherein
the manufacturing condition includes at least one of a design shape and a shaping posture of the shaped article,
the shaped article status is quality of the shaped article, and
the learning model is a model for determining, as the manufacturing condition to be estimated, the at least one of the design shape and the shaping posture of the shaped article when the quality that is the shaped article status is set as input data.

7. The additive manufacturing learning model generation apparatus according to claim 1, wherein
the additive manufacturing learning model generation apparatus is applied to a method for manufacturing a first-stage shaped article by radiating the light beam onto the layered metal powder and heating the metal powder, and manufacturing a second-stage shaped article by performing heat treatment for the first-stage shaped article,
the manufacturing condition is a condition of the heat treatment,
the shaped article status is quality of the shaped article, and
the learning model is a model for determining, as the manufacturing condition to be estimated, the condition of the heat treatment when the quality that is the shaped article status is set as input data.

8. The additive manufacturing learning model generation apparatus according to claim 1, wherein
the manufacturing condition includes at least one of laser power, a scanning speed, a scanning pitch, a radiation spot diameter, a layer thickness, a material of the metal powder, and a design shape and a shaping posture of the shaped article,
the shaped article status is quality of the shaped article, and
the learning model is a model for estimating the quality that is the shaped article status when the manufacturing condition is set as input data.

9. The additive manufacturing learning model generation apparatus according to claim 1, wherein
the additive manufacturing learning model generation apparatus is applied to a method for manufacturing a first-stage shaped article by radiating the light beam onto the layered metal powder and heating the metal powder, and manufacturing a second-stage shaped article by performing heat treatment for the first-stage shaped article,
the manufacturing condition is a condition of the heat treatment,
the shaped article status is quality of the shaped article, and
the learning model is a model for estimating the quality that is the shaped article status when the condition of the heat treatment that is the manufacturing condition is set as input data.

10. A manufacturing condition determination apparatus for a shaped article to be produced by additive manufacturing, the manufacturing condition determination apparatus comprising a condition determination unit configured to determine, by using the learning model according to claim 2, the manufacturing condition while the shaped article status is set as the input data.

11. A status estimation apparatus for a shaped article to be produced by additive manufacturing, the status estimation apparatus comprising an estimation unit configured to estimate, by using the learning model according to claim 2, the shaped article status while the manufacturing condition is set as the input data.
